(19) United States
(12) Patent Application Publication
(10) Pub. No.: US 2008/0127028 A1
(43) Pub. Date: May 29, 2008

(54) Integrated circuits verification checks of mask layout database, via the internet method and computer software

(76) Inventor: Dan Rittman, Atlit (IL)

Correspondence Address: Danny Rittman, P. O. Box 2040, Atlit, 30300, omitted

(21) Appl. No.: 11/604,147

(22) Filed: Nov. 27, 2006

(51) Int. Cl. G06F 17/50

(52) U.S. Cl. 716/19

(57) ABSTRACT

A system and method for integrated circuits verification checks of mask layout database, via the internet are disclosed. The method includes the submission of mask layout database for a specific verification check, over the internet to a main server. All required setup files are also submitted over the internet to the main server. The results are sent to the user upon check completion via email. The system includes a web based control panel interface to submit and execute all necessary setups and checks types for integrated circuit mask layout database over the internet using secured protocol, implemented within commercial internet browser. The system also offers a PDA (Personal Digital Assistant) interface to launch verification checks via the internet. This approach eliminates the purchase of a full local license and enables affordable prices for small and medium size chip design firms. This fact significantly reduces integrated circuits design cost and time to market factor for chip design corporations, enabling faster deliveries to their end customers.

### BACKGROUND OF INVENTION

1. Technical Field of the Invention

The present invention is generally related to the field of integrated circuits verification, and more particularly to a system and method for submitting a mask layout database verification check including all necessary setup and constraints files via a web based interface, using secured protocol, to a remote compute server. The remote compute server then executes a verification check according to user's request and notifies the user about the verification check completion via email. User may download all result files directly from a secure web location and view them locally. This process is accomplished using secured protocol though a commercial internet browser. The system supports multi-user usage via the internet. All verification jobs are submitted and executed via the main remote compute server according to order received and/or priority.

2. Background of the Invention

Nanometer designs contain millions of devices and operate at very high frequencies. To meet the challenges posed by such large-scale circuits, techniques have been developed to represent integrated circuit designs at various levels of abstraction. According to these techniques, an integrated circuit design may be represented by an electrical schematic containing devices and nets interconnecting the devices and by geometric layout data that describes patterns of regions or elements to be formed in and/or on an integrated circuit substrate. (e.g., wafer)

Techniques for managing highly integrated circuit designs include hierarchical design techniques. Using such techniques, a particular design is partitioned into functional cells and cells-within-cells, etc., so that at a given level of hierarchy the design may be analyzed as a set of cells and their respective interconnections, without being concerned with all the details of the contents of the cells (e.g., subcells within each cell).

These hierarchical techniques can be essential to the efficient performance of computer-assisted integrated circuit design verification. Such verification may include operations to perform layout versus schematic comparison (LVS) or design rule check (DRC) using computer-based design tools. As will be understood by those skilled in the art, tools to perform mask layout verification tasks are expensive and require significant amount of time to setup. Other mask layout verification tools like design for manufacturing (DFM) or retical enhancement technology (RET) are also expensive and time consuming regarding setups and execution.

The main advantage of the method and computer software that described in this invention is the capability of users to submit mask layout verification checks via a web based control panel using any secured web browser. This verification checks may be executed on a remote compute sever or the user's local computer. The advantage of submitting verification check on the remote compute server is based on the fact that the compute server is a fast super computer system that is capable of executing verification checks in a very short time. The system is based on web based control panel and can be used with any secured commercial web browser. User can setup any type of verification check using control panel's setup controls like check-boxes, buttons and pull-down menus. The communication with the main remote compute server is secured by 128 bit security protocol. All information remains fully confidential on the remote compute server. The main remote server is distributing the verification check among other CPU's systems for parallel processing, achieving faster results. In case that the user choose to submit verification check on his own local machine, the program offers an option to distribute the task on the user's local computer system for parallel processing to achieve faster results. When the verification check is complete, the user will be notified via the control panel and an optional email message about the check completion. The system offers any type of mask layout verification check for the entire IC layout block or incremental run for the updated IC layout cells only. The system provides a graphical and textual representation for the run progress and completion. The system supports existing industry standard rule decks formats to ensure compatibility. This feature includes design rule run sets, rule decks, LVS Netlist, LEF, DEF and SPEC. All results log files are available on the remote compute server or the user local server by the user's choice. The user is able to download all results files including violations marker file(s) to be loaded into mask layout database editor for visual viewing purposes.

One of the main advantages of this system is its capability to handle multi-user verification checks. Users from many integrated circuits design corporations may submit different types of verification checks at the same time. The system automatically executes the checks according to order received and/or pre-setup priority. Since the system is using advanced parallel processing algorithm all checks may be executed fast and on many other compute servers at the same time. This feature enables to provide cheaper verification checks capabilities to integrated circuits design houses.

Therefore, it is a primary object of the present invention to provide a method and software to submit wide variety of verification checks of IC layout database via the internet using commercial secured web browser. This method saves a significant amount of time during IC layout design verification. This method enables integrated circuit design corporations to annually license web based verification check system and therefore does not need to purchase complete verification software which is very expensive. This method and system significantly reduces the cost of integrated circuits verification checks and make it affordable for small and medium size integrated circuits design corporations. This fact enables corporations to become more profitable and successful on the long run.

### SUMMARY OF THE INVENTION

This and additional objects are accomplished by the present invention, wherein, briefly, verification checks of integrated circuit mask layout database can be submitted via the internet using commercial secured web browser.

The system offers a web based control panel to submit complete verification checks over the internet. The user has the option to submit the verification check locally (on his own computer system) or on a powerful remote server. In case of a local run, the system checks with the remote server about the existence of a software license. Upon getting the system's approval, the verification check will be submitted locally on the user's computer system. If the user chooses to submit verification check on the remote server, few pre-requisites setups are required. These setups include the submission of a mask layout GDSII/GDSIII file, the technology file, run sets, rule decks, netlists, LEF, DEF, SPEC and constrains file if exists. All these files are encrypted and securely transmitted using 128 bit security protocol to the remote server. On the remote server all received information is decrypted and the verification check is executed. The remote server is a multi-user system that executes many verification checks in parallel according to the order received or pre-setup priority. The remote server distributes all verification checks on other computer systems for parallel processing in order to achieve faster results. In case of a local verification check on the user's local computer, the system offers the option to distribute the verification execution task among user's local computer systems for parallel processing in order to achieve faster results. After verification check completion all necessary results, including log files and marker files are available for download directly from the remote server. In addition the system alerts the user via email about the verification task completion. In case of a local check all results file are available on the local machine. The system offers the option to run verification check in flat or fully hierarchical mode. The system offers incremental mode to run only the recent changed IC layout cells. The system offers a wide variety of verification checks types. The verification types are: Design Rule Check (DRC), Layout versus Schematics (LVS), Reliability Verification (RV), Noise, Design for Manufacturing (DFM), Reticle Enhancement Technology (RET), Static Timing Analysis (STA) and Functional Verification. By utilizing the described invention, corporations may save the cost of purchasing high end computer systems and software for integrated circuit verification and sign-off purposes. Offering advanced servers to submit verification checks, as described in this invention, enables fast run time for very large databases.

All, some, or none of these technical advantages may be present in various embodiments of the present invention. Other technical advantages will be readily apparent to one skilled in the art from the following figures, descriptions, and claims.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 illustrates a block diagram of a computer system for verification over internet (VOI) of a mask layout database under commercial secured internet browser in accordance with the teachings of the present invention.

FIG. 2 schematically illustrates the system basic components. The system includes remote internet server computer system to execute and route multi-user, multi-technology verification checks, submitted over the internet. The internet server routes multi-user's verification checks requests to the main verification checks execution server which runs checks according to order received and/or pre-set priority. The verification checks server may distribute the task among other CPU's for parallel processing in order to achieve faster results.

FIG. 3 schematically illustrates the system general flow. User submits a verification check request through a web based interface. The web based interface is operated via a computer program that is executed on the internet server. All users' data is encrypted and securely entered to a job's queue on the internet server. The queue can be prioritized by the internet server's system administrator. The internet server's program also validates all users' data and setup files existence and correctness. The job is submitted to the verification check server, to be executed according to the queue order. Upon verification check completion all results files (Log File and Violation marker files) are available for download via web interface. The user also has the option to be notified by email.

### DESCRIPTION OF A PREFERRED EMBODIMENT

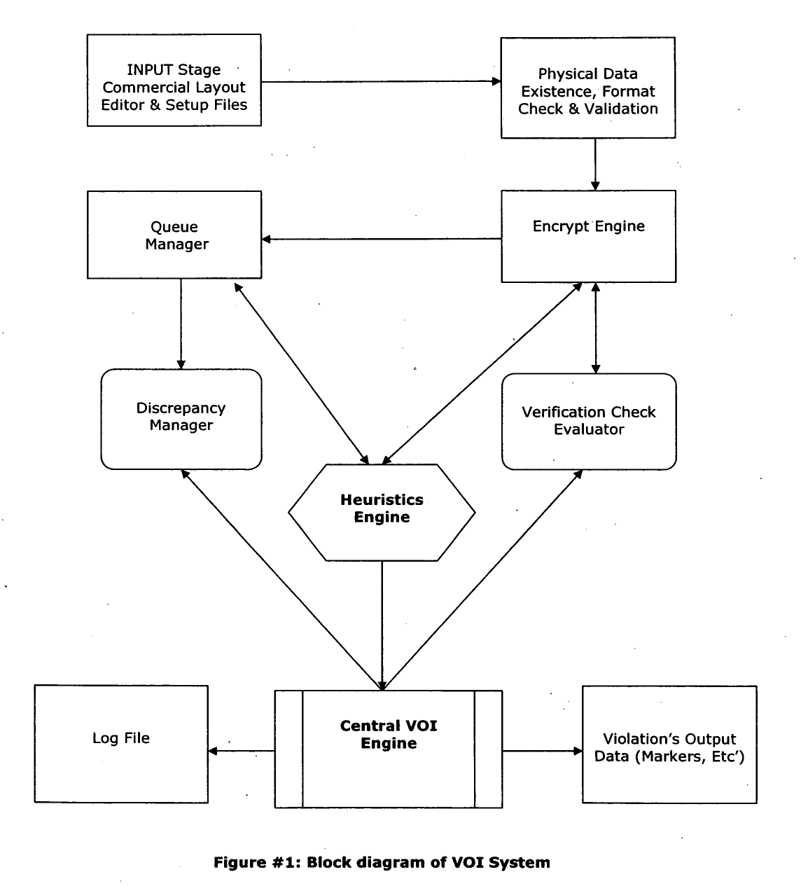

Referring to FIG. 1, conceptually illustrates is the functional block diagram of a VOI system. (Verification over Internet)

INPUT Module—The system consists of INPUT module for reading mask layout database and necessary setup files.

Physical Data Processor—The Physical Data Processor verifies setup files existence, format and correctness.

Encrypt Engine—This module encrypts all users' input using 128 bit encryption algorithm.

Queue Manger—Is responsible for multi-user verification checks submission order. Here the system admin can se the priority and submission order.

Verification Check Evaluator—This part of the program is routing the verification check according to its type. For example Design Rule Check will be routed to the DRC check sub-program.

Discrepancy Manger—This module is categorizing and analyzing all found violations according to the verification check type. For example, for LVS verification check, this module will prepare a violation report to be loaded by the system's violation browser within selected commercial layout editor. In addition this module is creating the violations markers output files, to be loaded on selected commercial mask layout editors.

Heuristic Engine—The heuristic engine is the core of the entire system. It works with the program that runs on the Internet Server and the program that runs on the verification check server. It is responsible to efficiently executing multi-technology, multi-user, multi-verification check types using local or remote parallel processing.

VOI Engine—Is the mechanism that connects the web interface data and the heuristic engine. It is combined with geometrical, connectivity and extraction engines to provide fast analysis of the mask layout database according to verification check type.

Log File—Is a detailed log file that is produced upon the completion of a verification check. The log files are available via the web interface or optional email.

Violation output data—An advanced violation browser system for quick navigation to the selected violations under selected commercial mask layout editors.

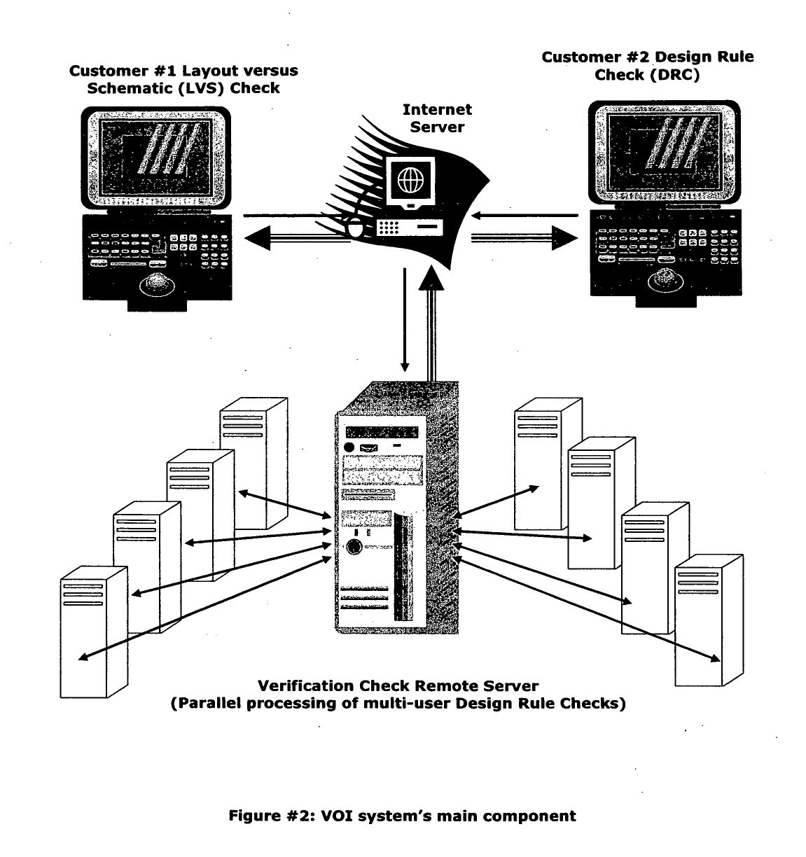

Referring to FIG. 2, conceptually illustrates is the component diagram of a VOI system. (Verification over Internet)

The system consists of two (2) major components. Component #1 is the internet server and component #2 is the verification check server. The internet server is a powerful computer to route all verification checks requests according to priority and queue to the executing server. The verification check remote server is a powerful super computer that distributes all verification checks information for parallel processing execution on other computer systems at a main location. The main computer program is running on the verification check remote server and can handle multi-user, multi-technology verification checks execution. All technology files, design rule run sets and other necessary setup files are encrypted before sent to the main check server. This information then is decrypted at the main verification check server and executed. A separate computer program that is synchronized with the verification check program and is running on the internet server to manage verification checks requests traffic, priority and queue. When each verification check is complete all results are automatically available on the main verification check remote server. The verification check remote server informs the internet server about the verification check completion, which inform the user about the run completion and the availability of the result files.

The computer software is working on GDSII, GDSIII Stream and commercial layout format database (industry standard IC layout representation database) in order to cover all the commercial layout editors in the VLSI field today. In addition the system works with all necessary setup files, rule decks, run sets, netlists, LEF, DEF, SPEC and other necessary setup files.

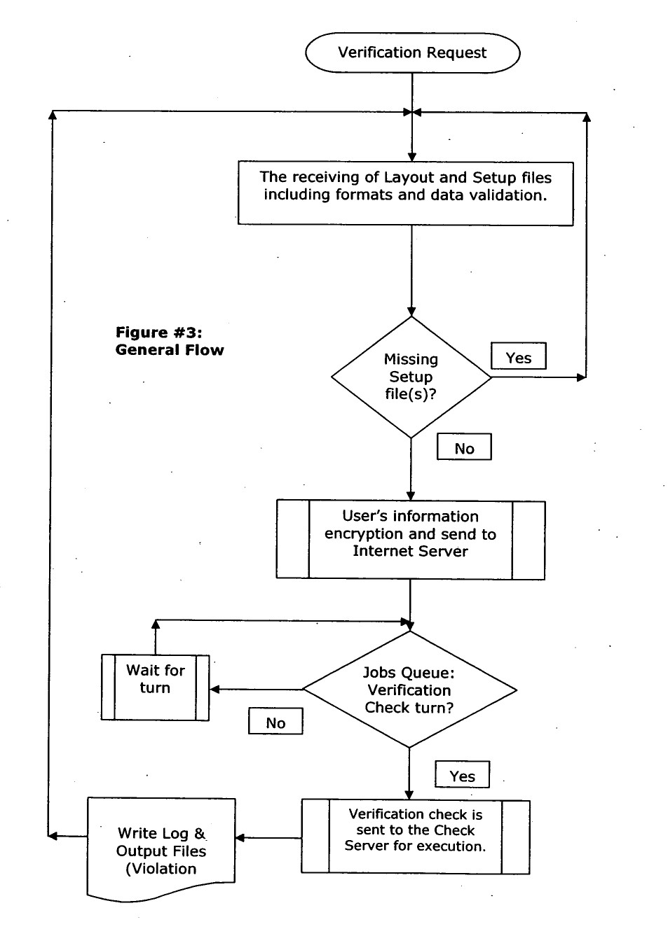

FIG. 3 illustrates a general flow of a method and system for verification over the internet of a mask layout block via secured commercial internet browser in accordance with teachings of the present invention.

### DETAILED DESCRIPTION OF THE INVENTION

The processing instructions may include a commercially available secured internet browser with an access to the internet.

A layout designer creates a mask layout block and may desire to run a specific verification check. This verification check may be design rule check (DRC), layout versus schematics (LVS), Reliability (RV) and similar. The user uses a secured commercial internet browser to access the described invention web page that offers a secured interface to submit any type of verification check. Upon a setup of a desired verification check, the user submits all necessary files, including completed mask layout file and submit the run via the web interface.

The web based software is encrypting all users' files and setups and uploading them into the internet server for later re-route to the verification check server. All check details, files and setups are contained within one Run Package, automatically prepared by the internet server computer program. The check is entering a queue and will be submitted to the main verification check server according to the order received. In case of urgent projects, execution order can be pre-set according to priority by the verification check program's system administrator.

When check is completed all result files are available on the program's main web page. The user has the option to be notified about the check completion via email. In case of re-run all setup files are already in the system. The user required to re-submits the up-to-date layout database only.

The tool has an option to import industry's standard rule decks, run sets, netlists, LEF, DEF and SPEC files and automatically translate them into the system's internal format. The system also offers the option to submit another constraints file which contains layout or schematics additional information.

Upon the completion of a specific verification task the user may download the result files and load them into a commercial mask layout editor for violation review. The system offers advanced violation browser to quickly navigate between violation markers including zoom in into the desired violation. The system also provides a detailed explanation about each violation using an Information Window graphical representation. The system operates in flat mode and hierarchical mode.

The processing instructions for verification over the internet (VOI) of integrated circuit layout block database using secured commercial internet browser environment may be encoded in computer-usable media. Such computer-usable media may include, without limitation, storage media such as floppy disks, hard disks, CD-ROMS, DVDs, read-only memory, and random access memory; as well as communications media such wires, optical fibers, microwaves, radio waves, and other electromagnetic or optical carriers.

1. An automated method and system for integrated circuits mask layout database verification checks via the internet using a commercial internet browser, comprising: submission of mask layout database including all necessary setups and constraints files via a web based interface, using secured protocol; and submit a verification check according to user's request; and process the verification check on a remote compute server; and notifying the user about the verification check completion via email; and providing the verification check results using a web based interface, using secured protocol though a commercial internet browser.

2. The method and system of claim 1, wherein the verification check submitted is design rule check for integrated circuit mask layout database. (DRC)

3. The method and system of claim 1, wherein the verification check submitted is layout versus schematic check for integrated circuit mask layout database. (LVS)

4. The method and system of claim 1, wherein the verification check submitted is reliability check for integrated circuit mask layout database. (RV) This check may consist of electromigration, IR Drop, Self Heat, Thermal Analysis and Soft Errors.

5. The method and system of claim 1, wherein the verification check submitted is design for manufacturing check for integrated circuit mask layout database. (DFM)

6. The method and system of claim 1, wherein the verification check submitted is noise check for integrated circuit mask layout database. (Noise)

7. The method and system of claim 1, wherein the verification check submitted is reticle enhancement technology checks for integrated circuit mask layout database. (RET) This check may be consisted of Optical Correction Check (OPC), Phase Shift Mask (PSM) and other related topics.

8. The method and system of claim 1, wherein the verification check submitted is static timing analysis check for integrated circuit mask layout database. (STA)

9. The method and system of claim 1, wherein the verification check submitted is functional verification check for integrated circuit mask layout database.

10. The method and system according to claim 1 wherein said that the remote compute server may distribute the verification check among other servers for parallel processing to achieve faster results.

11. The method and system according to claim 1 wherein the verification check is done on the remote compute server or on the user's local server according to the user's choice, enabled by the web based control panel interface.

12. The method and system according to claim 1 wherein users' information is encrypted using 128 bit security protocol and sent to the remote server.

13. The method and system according to claim 1 includes an internet traffic server to route multi-users verifications checks to a main execution remote server according to priority and queue.

14. The method and system according to claim 1 may import industry's standard run sets, rule decks or netlist files for extracting verification check's necessary information. The system supports existing industry standard commercial rule decks, run set, netlists, LEF Format and format.

15. The method and system according to claim 1 may produces an output marker file with all violations location and type according to the verification type submitted. This markers information can be load and viewed into any industry's standard commercial IC layout editor.

16. The method and system according to claim 1, wherein the verification check is been performed on a flat or hierarchical integrated circuit layout mask layout database.

17. The method and system according to claim 1, wherein said verification check run can be setup and submitted via standard PDA (Personal Digital Assistant) with an access to the internet.

18. The method and system according to claim 1 wherein said can be submitted via cellular devices or any WiFi and WiMax technology based computer with an access to the internet.

19. The method and system according to claim 1 supports multi-user, multi-technology verification checks executions and analysis.

20. The method and system according to claim 1 alerts the user about the verification check completion via email and graphical representation show on the web based control panel interface.

21. The method and system according to claim 1 provides a run-time graphical and textual indicators to show the verification check run progress and completion time estimation.

22. The method and system according to claim 1 provides incremental verification check option to run only changed integrated circuit mask layout cells or blocks.

23. A computer system for integrated circuits mask layout database verification checks via the internet using a commercial internet browser, comprising: a processing resource; a computer readable memory; and processing instructions encoded in the computer readable memory, the processing instructions, when executed by the processing resource, operable to perform operations comprising: the submission of mask layout database including all necessary setup and constraints file via a web based interface, using secured protocol; and execute a verification check according to user's request; and process the verification check on a remote compute server; and notifying the user about the verification check completion via email; and providing the verification check results using a web based interface, using secured protocol though a commercial internet browser.

24. Software for integrated circuits mask layout database verification checks via the internet using a commercial internet browser, the software being embodied in computer-readable media and when executed operable to: read integrated circuit database file in GDSII, GDSIII formats or commercial formats database and; submit the mask layout database including all necessary setup and constraints files via a web based interface, using secured protocol, to a remote compute server; and execute a verification check according to user's request; process the verification check on a remote compute server; notify the user about the verification check completion via email; and providing the verification check results using a web based interface, using secured protocol though a commercial internet browser.

25. The software of claim 24, further operable to automatically submit an integrated circuit mask layout database through a web based interface, using secured protocol.

26. The software of claim 24, further operable to submit and setup verification check via standard PDA (Personal Digital Assistant) with an access to the internet.

27. The software of claim 24, further operable to submit verification check or setup via cellular devices or any WiFi and WiMax technology based computer with an access to the internet.

28. The software of claim 24, further operable to support multi-user, multi-technology verification checks executions and analysis.

29. The software of claim 24, further operable to provide run-time graphical and textual indicators to show the verification check run progress and completion time estimation on standard PDA (Personal Digital Assistant) with an access to the internet.

30. The software of claim 24, wherein the mask layout block is flat or hierarchical.
